(19) United States
(12) Patent Application Publication
(10) Pub. No.: US 2003/0119470 A1
(43) Pub. Date: Jun. 26, 2003

(54) Generating local oscillator signals for downconversion

(76) Inventor: Charles J. Persico, Rancho Santa Fe, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 10/027,638

(22) Filed: Dec. 21, 2001

(51) Int. Cl. H04B 1/26

(52) U.S. Cl. 455/323; 455/318; 455/313

(57) ABSTRACT

A local oscillator signal for direct downconversion is generated using an upper frequency oscillator signal and a lower frequency oscillator signal, both of which have frequencies different from a frequency of an RF input signal. The local oscillator signal thus generated has a frequency that is either the sum or the difference of the frequencies of the upper and lower frequency oscillator signals. As a result, the risk of local oscillator signals re-radiating and coupling the RF signal input is significantly reduced. In addition, in QPSK systems, a quadrature local oscillator signal can be generated with accurate phasing relative to an in-phase local oscillator signal.

### FIELD

The disclosed embodiments relate to wireless communication and, more particularly, to downconversion in a wireless communication system.

### BACKGROUND

Wireless communication systems are widely deployed to provide various types of communication, such as voice and data communications. These systems may be based on a variety of modulation techniques, such as frequency division multiple access (FDMA), time division multiple access (TDMA), and various spread spectrum techniques. One common spread spectrum technique used in wireless communications is code division multiple access (CDMA) signal modulation. In CDMA, multiple communications are simultaneously transmitted over a spread spectrum radio frequency (RF) signal. Some example wireless communication devices (WCDs) that have incorporated CDMA technology include cellular radiotelephones, satellite radiotelephones, PCMCIA cards incorporated within portable computers, personal digital assistants (PDAs) equipped with wireless communication capabilities, and the like. A CDMA system provides certain advantages over other types of systems, including increased system capacity and quality of service.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in a set of documents including “C.S0002-A Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), and (4) some other standards.

Other wireless communication systems may use different modulation techniques. For example, GSM systems use a combination of TDMA and FDMA modulation techniques. These techniques are also used in other systems related to GSM systems, including the DCS1800 and PCS1900 systems, which operate at 1.8 GHz and 1.9 GHz, respectively

In many wireless communication systems, an RF input signal is converted to one or more baseband signals to extract the information carried by the RF signal. For example, in systems employing quadrature phase shift keying (QPSK), the RF input signal is converted into an in-phase (I) baseband signal and a quadrature (Q) baseband signal through a process known as downconversion. Some conventional downconversion processes involve converting the RF signal down to an intermediate frequency (IF) signal and converting the IF signal to the baseband signal or signals.

The RF input signal can alternatively be converted down to a baseband signal or signals without first converting the RF signal down to an IF signal in a process known as direct downconversion. Because the RF signal is not converted to an IF signal, direct downconversion eliminates the need for IF circuitry, reducing implementation costs and allowing for smaller form factors. Direct downconversion involves the use of an external ultra high frequency (UHF) local oscillator, which may have the same frequency as the RF signal, e.g., 800 MHz.

### SUMMARY

In one embodiment, a wireless communication device has a downconverter to generate at least one baseband signal as a function of both an RF signal and a local oscillator signal. The local oscillator signal has a frequency determined as a function of first and second frequencies different from a frequency of the RF signal. A modem demodulates the baseband signal.

Another embodiment is directed to a method in which a first signal having a first frequency and a second signal having a second frequency are received. The first and second frequencies are different from a frequency of an RF signal. At least one local oscillator signal is generated having a frequency determined as a function of the first and second frequencies. At least one baseband signal is generated as a function of the local oscillator signal and the RF signal.

Various embodiments may be implemented in software, hardware, firmware, or any combination thereof. Software embodiments may include a processor readable medium carrying program code, that when executed, performs one or more of the methods mentioned above.

Additional details of various embodiments are set forth in the accompanying drawings and the description below. Other features, objects and advantages will become apparent from the description and drawings, and from the claims.

### BRIEF DESCRIPTION OF THE DRAWINGS

FIG. 1 is a block diagram illustrating a wireless communication system.

FIG. 2 is a block diagram depicting an example implementation of a WCD.

FIG. 3 is a block diagram illustrating example hardware for implementing a direct downconversion technique.

FIG. 4 is a flow diagram illustrating a mode of operation of the hardware of FIG. 3.

FIG. 5 is a block diagram illustrating example hardware for generating in-phase and quadrature local oscillator signals.

FIG. 6 is a schematic diagram illustrating an example phase shifting circuit.

FIG. 7 is a schematic diagram illustrating another example phase shifting circuit.

### DETAILED DESCRIPTION

In general, direct downconversion is facilitated by using a local oscillator generation circuit having an upper local oscillator frequency and a lower local oscillator frequency, both of which are different from the RF signal frequency. The local oscillator generation circuit selectively forms either the sum or the difference of the upper and lower local oscillator frequencies.

With the upper and lower local oscillator frequencies different from the RF signal frequency, the in-phase and quadrature local oscillator signals can be generated on chip and can be implemented using balanced, differential signals. As a result, the risk of local oscillator signals re-radiating and coupling the RF signal input is significantly reduced, thereby reducing the occurrence of time-varying DC offsets that are difficult to filter out. In addition, in QPSK systems, the local oscillator generator circuit can generate a quadrature local oscillator signal with accurate phasing, i.e., a quadrature local oscillator signal having a 90° phase offset relative to the in-phase local oscillator signal.

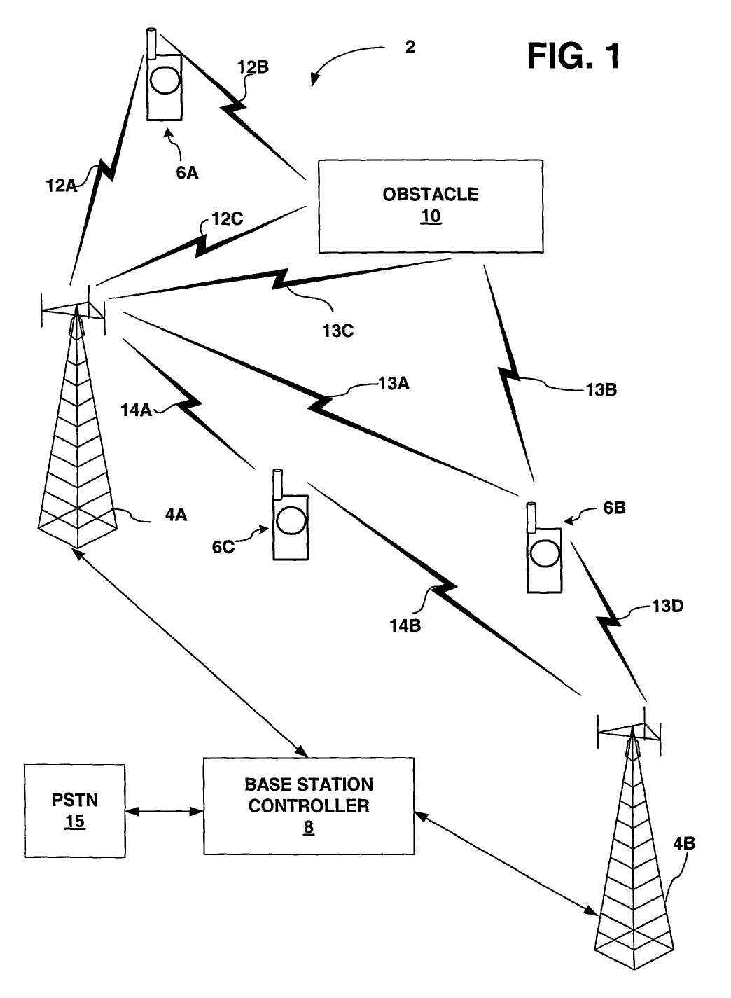

FIG. 1 is a block diagram illustrating an example spread spectrum wireless communication system 2, in which base stations 4 transmit signals 12-14 to WCDs 6 via one or more paths. In particular, base station 4A transmits signal 12A to WCD 6A via a first path, as well as signal 12C, via a second path caused by reflection of signal 12B from obstacle 10. Obstacle 10 may be any structure proximate to WCD 6A such as a building, bridge, car, or even a person.

Base station 4A also transmits signal 13A to WCD 6B via a first path from base station 4A, as well as signal 13C via a second path caused by reflection of signal 13B from obstacle 10. In addition, base station 4A transmits signal 14A to WCD 6C. WCDs 6 may implement what is referred to as a RAKE receiver to simultaneously track the different signals received from different base stations and/or from the same base station but via different paths. System 2 may include any number of WCDs and base stations. For example, as illustrated, another base station 4B receives signal 13D from WCD 6B. In addition, base station 4B receives signal 14B from WCD 6C.

System 2 may be designed to support one or more CDMA standards including, for example, (1) the “TIA/EIA-95-B Mobile Station-Base Station Compatibility Standard for Dual-Mode Wideband Spread Spectrum Cellular System” (the IS-95 standard), (2) the “TIA/EIA-98-C Recommended Minimum Standard for Dual-Mode Wideband Spread Spectrum Cellular Mobile Station” (the IS-98 standard), (3) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (4) the standard offered by a consortium named “3rd Generation Partnership Project 2” (3GPP2) and embodied in a set of documents including “TR-45.5 Physical Layer Standard for cdma2000 Spread Spectrum Systems,” the “C.S0005-A Upper Layer (Layer 3) Signaling Standard for cdma2000 Spread Spectrum Systems,” and the “C.S0024 CDMA2000 High Rate Packet Data Air Interface Specification” (the CDMA2000 standard), (5) the HDR system documented in TIA/EIA-IS-856, “CDMA2000 High Rate Packet Data Air Interface Specification, and (6) some other standards. In addition, system 2 may be designed to support other standards, such as the GSM standard or related standards, e.g., the DCS1800 and PCS1900 standards. GSM systems employ a combination of FDMA and TDMA modulation techniques. System 2 may also support other FDMA and TDMA standards.

WCDs 6 may be implemented as any of a variety of wireless communication devices such as, for example, a cellular radiotelephone, a satellite radiotelephone, a PCMCIA card incorporated within a portable computer, a personal digital assistant (PDA) equipped with wireless communication capabilities, and the like. Base stations 4 (sometimes referred to as base transceiver systems, or BTSs) are typically connected to a base station controller (BSC) 8 to provide an interface between base stations 4 and a public switched telephone network 13.

One or more of WCDs 6 may convert incoming RF signals received from base stations 4 to baseband signals by direct downconversion, thereby eliminating the need for IF circuitry and reducing implementation costs and device real estate requirements. In some embodiments, a quadrature signal generator is used to generate in-phase (I) and quadrature (Q) local oscillator signals that are mixed with an incoming RF signal to generate I- and Q-baseband signals. The I- and Q-local oscillator signals are generated using an upper frequency oscillator signal and a lower frequency oscillator signal, both of which have frequencies different from the frequency of the received RF signal. The quadrature signal generator forms the I- and Q-local oscillator signals with a frequency of either the sum or the difference of the frequencies of the upper and lower frequency oscillator signals. Because neither the upper frequency nor the lower frequency is the same as the frequency of the received RF signal, the risk of re-radiated local oscillator coupling to the RF signal is reduced.

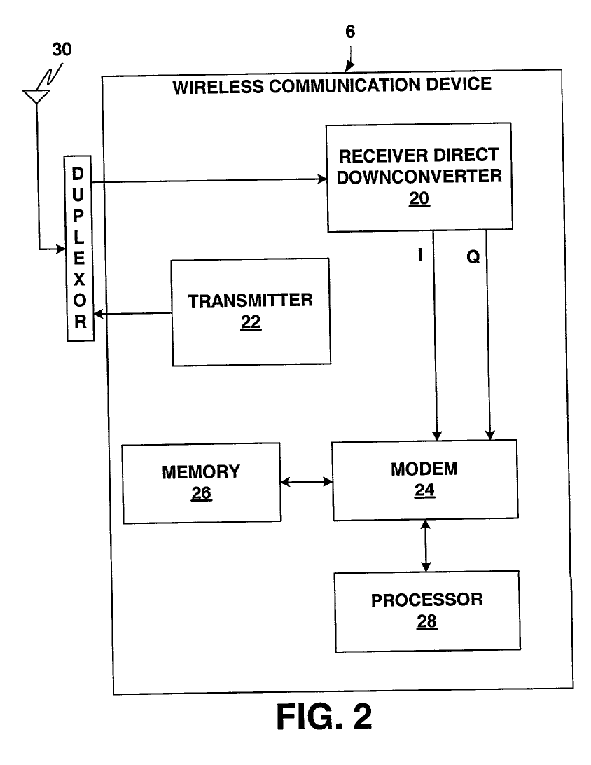

FIG. 2 is a block diagram illustrating an example wireless communication device (WCD) 6 having a direct downconverter 20 that generates I- and Q-local oscillator signals based on upper and lower frequency oscillator signals as described above in connection with FIG. 1. WCD 6 may be designed to support one or more CDMA standards and/or designs, such as the W-CDMA standard, the IS-95 standard, the cdma2000 standard, and the HDR specification. WCD 6 may also support other standards, such as the GSM standard, and may therefore be configured to transmit TDMA or FDMA signals, or both.

As shown in FIG. 2, WCD 6 may include, in addition to a radio frequency (RF) receiver direct downconverter 20, a radio frequency (RF) transmitter 22, a modem 24, a memory 26, a processor 28 and a radio frequency antenna 30. In addition, WCD 6 may include other circuitry that is not depicted in FIG. 2, such as channel searching hardware.

Receiver downconverter 20 receives an RF signal via antenna 30. Direct downconverter 20 converts the RF signal down to I- and Q-baseband signals, which are provided to modem 24. Modem 24 includes demodulator/decoder circuitry and modulator/encoder circuitry for receiving and transmitting the communication signals. When receiving communication signals, modem 24 demodulates the I- and Q-baseband signals according to a QPSK demodulation scheme. Modem 24 provides the demodulated signals to processor 28, which converts the demodulated signals to voice and data outputs.

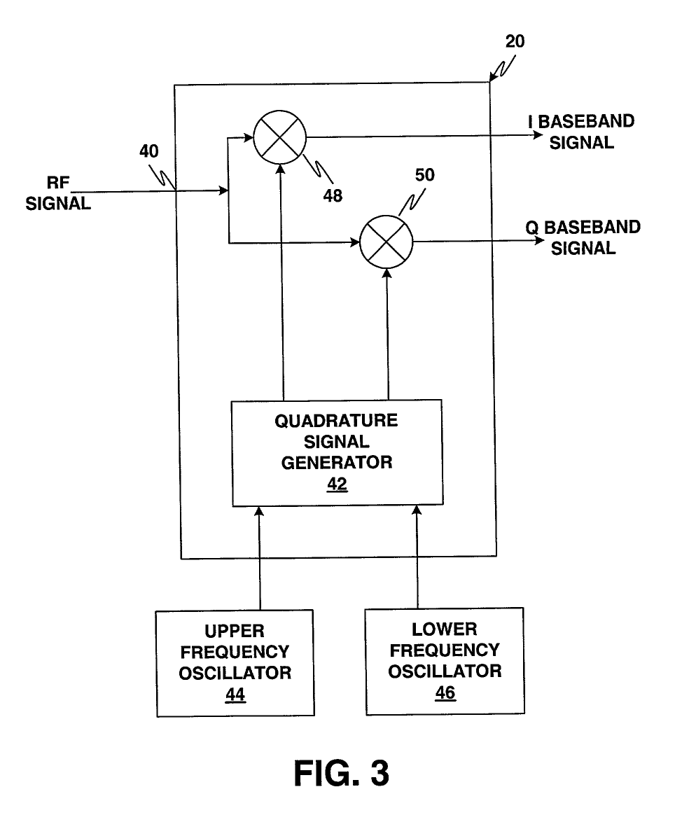

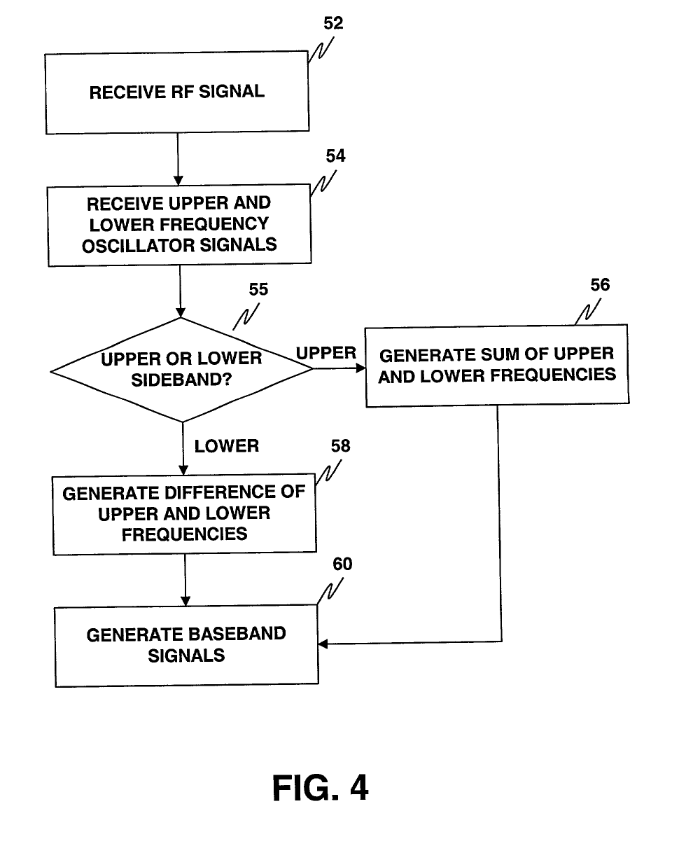

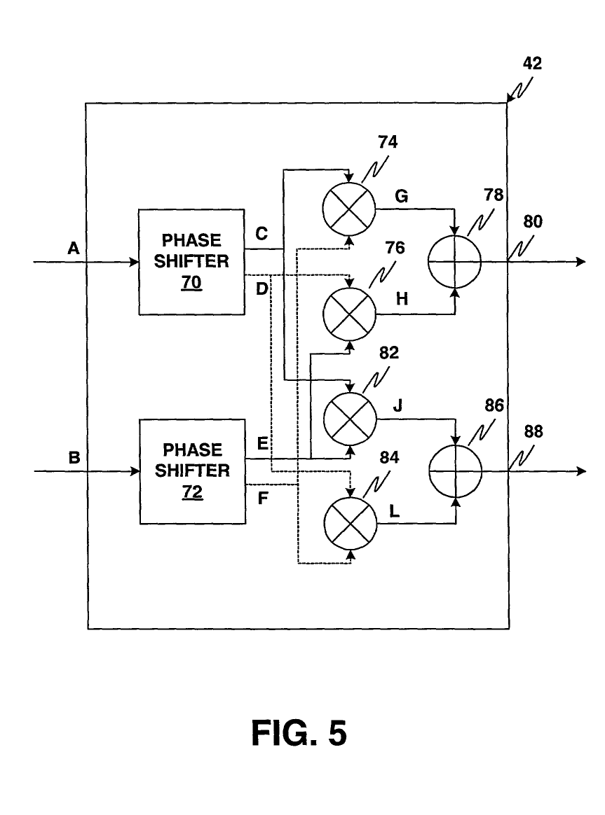

Downconverter 20 converts the RF signal down to baseband signals by mixing the RF signal with in-phase (I) and quadrature (Q) local oscillator signals. These local oscillator signals are generated by a quadrature signal generator, as described below in connection with FIGS. 3 and 4. The quadrature signal generator receives two oscillator signals as inputs. One of these oscillator signals has a UHF frequency different from the frequency of the RF signal. The other oscillator signal has an IF frequency, which is lower than the UHF frequency and also different from the RF signal frequency. As described below in connection with FIG. 5, the quadrature signal generator forms the I and Q local oscillator signals with a frequency equal to either the sum or the difference of the UHF and IF frequencies.

FIG. 3 illustrates an example implementation of downconverter 20. A mode of operation of downconverter 20 is depicted in FIG. 4. Downconverter 20 receives an incoming RF signal (52) at an input 40. The RF signal has a frequency specified by the communication system used by WCD 6. For purposes of illustration and not limitation, it is assumed that the RF signal has a frequency of 800 MHz. Downconverter 20 also receives an upper frequency oscillator signal and a lower frequency oscillator signal (54). More particularly, a quadrature signal generator 42 receives the upper frequency oscillator signal from an upper frequency oscillator 44 located external to downconverter 20. The upper frequency oscillator signal has a UHF frequency different from the RF signal frequency. Quadrature signal generator 42 receives the lower frequency oscillator signal from a lower frequency oscillator 46, which may be either external to downconverter 20, as shown in FIG. 3, or integrated with downconverter 20. The lower frequency oscillator signal has an IF frequency lower than the UHF frequency. By way of example, the UHF and IF frequencies may be 1100 MHz and 300 MHz, respectively.

Quadrature signal generator 42 may be dynamically configurable (55) to generate either the quadrature upper sideband (56), i.e., the frequency sum of the upper and lower frequencies, or the quadrature lower sideband (58), i.e., the frequency difference of the upper and lower frequencies. For example, if the UHF and IF frequencies are 1100 MHz and 300 MHz, the I- and Q-local oscillator signals can have a frequency of either 800 MHz or 1400 MHz. If the RF signal frequency is 800 MHz, quadrature signal generator 42 is configured to generate the quadrature lower sideband. It will be appreciated that the 800 MHz frequency can also be obtained, for example, as the sum of UHF and IF frequencies of 500 MHz and 300 MHz. By using either the quadrature upper sideband or the quadrature lower sideband, I- and Q-local oscillator signals can be generated with the RF signal frequency without the use of an external local oscillator signal having the same frequency as the RF signal. In this manner, re-radiated local oscillator coupling can be reduced or eliminated, thereby reducing time-varying DC offsets that are difficult to filter out.

The I- and Q-local oscillator signals generated by quadrature signal generator 42 have an accurate quadrature phase relationship, i.e., a 90° offset between the I- and Q-local oscillator signals. The I- and Q-local oscillator signals are applied to mixers 48 and 50, respectively. Mixers 48 and 50 mix the incoming RF signal with the I- and Q-local oscillator signals to produce the I- and Q-baseband signals (60).

FIG. 5 depicts one implementation of quadrature signal generator 42. In FIG. 5, the letters A, B, C, D, E, F, G, H, J, and L are used to denote various signals. Broken lines denote quadrature signals. In this discussion, subscripted values of K denote constants. A phase shifter 70 receives an upper frequency oscillator signal A that may be represented as A=K_{U}sin(ω_{U}t). Phase shifter 70 shifts the upper frequency oscillator signal A by a phase offset θ to generate an in-phase upper frequency oscillator signal C and a quadrature upper frequency oscillator signal D:

C=K_{C}sin((ω_{U}t+θ)

D=K_{D}sin((ω_{U}t+θ−90°)

Likewise, a phase shifter 72 receives a lower frequency oscillator signal B:

B=K_{L}sin(ω_{L}t)

and shifts the signal B by a phase offset φ. In this manner, phase shifter 72 generates an in-phase lower frequency oscillator signal E and a quadrature lower frequency oscillator signal F:

E=K_{E}sin(ω_{L}t+φ)

F=K_{F}sin(ω_{L}t+φ−90°)

By mixing the in-phase upper frequency oscillator signal C and the quadrature lower frequency oscillator F, a mixer 74 generates a signal G as C*F:

$$\begin{matrix}G = C * F \\ = ( {K}_{C} sin ( {ω}_{U} t + θ ) ) * ( {K}_{F} sin ( {ω}_{L} t + φ - 90 ° ) ) \\ = ( ( {K}_{C} {K}_{F} ) / 2 ) [ cos ( {ω}_{U} t + θ - {ω}_{L} t - φ + 90 ° ) - \\ cos ( {ω}_{U} t + θ + {ω}_{L} t + φ - 90 ° ) ]\end{matrix}$$

Similarly, a mixer 76 generates a signal H by mixing the quadrature upper frequency oscillator signal D and the in-phase lower frequency oscillator signal E:

$$\begin{matrix}H = D * E \\ = ( {K}_{D} sin ( {ω}_{U} t + θ - 90 ° ) ) * ( {K}_{E} sin ( {ω}_{L} t + φ ) ) \\ = ( ( {K}_{D} {K}_{E} ) / 2 ) [ cos ( {ω}_{U} t + θ - 90 ° - {ω}_{L} t - φ ) - \\ cos ( {ω}_{U} t + θ - 90 ° + {ω}_{L} t + φ ) ]\end{matrix}$$

A summer 78 generates the in-phase local oscillator signal at an output 80. To generate the lower sideband (ω_{U}t−ω_{L}t) of the input upper frequency oscillator signal A and the lower frequency oscillator signal B, summer 78 outputs the difference of the signals G and H. Assuming for purposes of simplification that K_{C}=K_{D}=K_{E}=K_{F}=1, the lower sideband is:

$$( [ cos ( {ω}_{U} t + θ - {ω}_{L} t - φ + 90 ° ) - cos ( {ω}_{U} t + θ + {ω}_{L} t + φ - 90 ° ) ] - [ cos ( {ω}_{U} t + θ - 90 ° - {ω}_{L} t - φ ) - cos ( {ω}_{U} t + θ - 90 ° + {ω}_{L} t + φ ) ] ) = 2 ( cos ( {ω}_{U} t + θ + {ω}_{L} t + φ + 90 ° ) ) .$$

If, on the other hand, quadrature signal generator 42 is configured to generate the upper sideband (ω_{U}t+ω_{L}t), summer 78 outputs the sum of the signals G and H. Again assuming that K_{C}=K_{D}=K_{E}=K_{F}=1, the upper sideband is:

$$( [ cos ( {ω}_{U} t + θ - {ω}_{L} t - φ + 90 ° ) - cos ( {ω}_{U} t + θ + {ω}_{L} t + φ - 90 ° ) ] + [ cos ( {ω}_{U} t + θ - 90 ° - {ω}_{L} t - φ ) - cos ( {ω}_{U} t + θ - 90 ° + {ω}_{L} t + φ ) ] ) = 2 ( cos ( {ω}_{U} t + θ + {ω}_{L} t + φ + 90 ° ) ) .$$

To generate the quadrature local oscillator signal, a mixer 82 mixes the in-phase upper frequency oscillator signal C and the in-phase lower frequency oscillator signal E to generate a signal J:

$$\begin{matrix}J = C * E \\ = ( {K}_{C} sin ( {ω}_{U} t + θ ) ) * ( {K}_{E} sin ( {ω}_{L} t + φ ) ) \\ = ( ( {K}_{C} {K}_{E} ) / 2 ) [ cos ( {ω}_{U} t + θ - {ω}_{L} t - φ ) - cos ( {ω}_{U} t + θ + {ω}_{L} t + φ ) ]\end{matrix}$$

Likewise, a mixer 84 generates a signal L by mixing the quadrature upper frequency oscillator signal D and the quadrature lower frequency oscillator F:

$$\begin{matrix}L = D * F \\ = ( {K}_{D} sin ( {ω}_{U} t + θ - 90 ° ) ) * ( {K}_{F} sin ( {ω}_{L} t + φ - 90 ° ) ) \\ = ( ( {K}_{D} {K}_{F} ) / 2 ) [ cos ( {ω}_{U} t + θ - {ω}_{L} t - φ ) + cos ( {ω}_{U} t + θ + {ω}_{L} t + φ ) ]\end{matrix}$$

To generate the lower sideband, a summer 86 then generates the quadrature local oscillator signal at an output 88 as the sum of signals J and L. The quadrature local oscillator signal is thus:

$$( [ cos ( {ω}_{U} t + θ - {ω}_{L} t - φ ) - cos ( {ω}_{U} t + θ + {ω}_{L} t + φ ) ] + [ cos ( {ω}_{U} t + θ - {ω}_{L} t - φ ) + cos ( {ω}_{U} t + θ + {ω}_{L} t + φ ) ] ) = 2 ( cos ( {ω}_{U} t + θ - {ω}_{L} t - φ ) )$$

To generate the upper sideband, summer 86 instead generates the quadrature local oscillator signal at output 88 as the difference of signals J and L:

$$( [ cos ( {ω}_{U} t + θ - {ω}_{L} t - φ ) - cos ( {ω}_{U} t + θ + {ω}_{L} t + φ ) ] - [ cos ( {ω}_{U} t + θ - {ω}_{L} t - φ ) + cos ( {ω}_{U} t + θ + {ω}_{L} t + φ ) ] ) = 2 ( cos ( {ω}_{U} t + θ + {ω}_{L} t + φ ) )$$

In this manner, summers 78 and 86 generate the in-phase (I) and quadrature (Q) local oscillator signals. The upper and lower frequencies are selected such that either their sum or their difference is equal to the RF signal frequency. If quadrature signal generator 42 is configured to generate the upper sideband, the upper and lower frequencies are selected such that their sum is equal to the RF signal frequency. On the other hand, if quadrature signal generator 42 is configured to generate the lower sideband, the upper and lower frequencies are selected such that their difference is equal to the RF signal frequency. In either case, the upper and lower frequency oscillator signals are unlikely to re-radiate and couple with the RF signal. In addition, the resulting I- and Q-local oscillator signals provide a highly accurate quadrature phase relationship. As a result, phase shifters 70 and 72 only need to realize moderately accurate phase control.

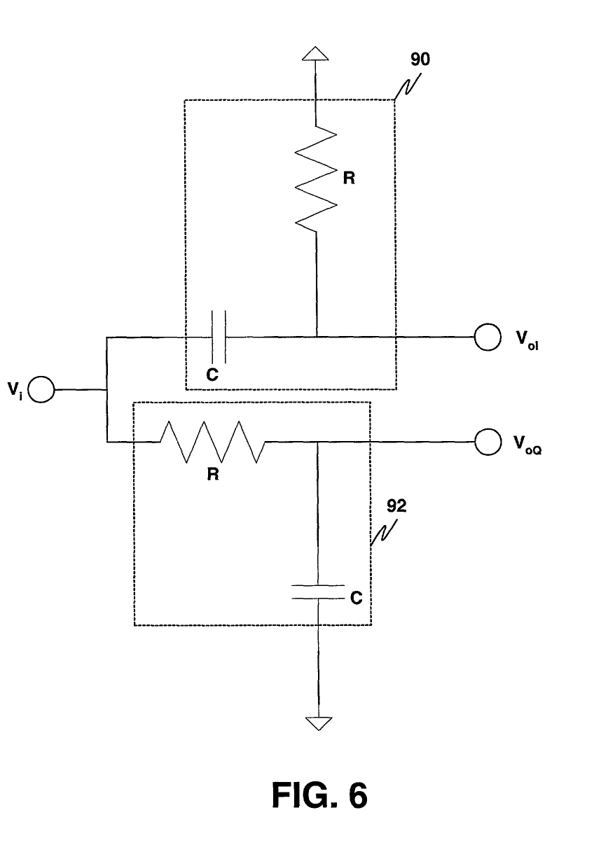

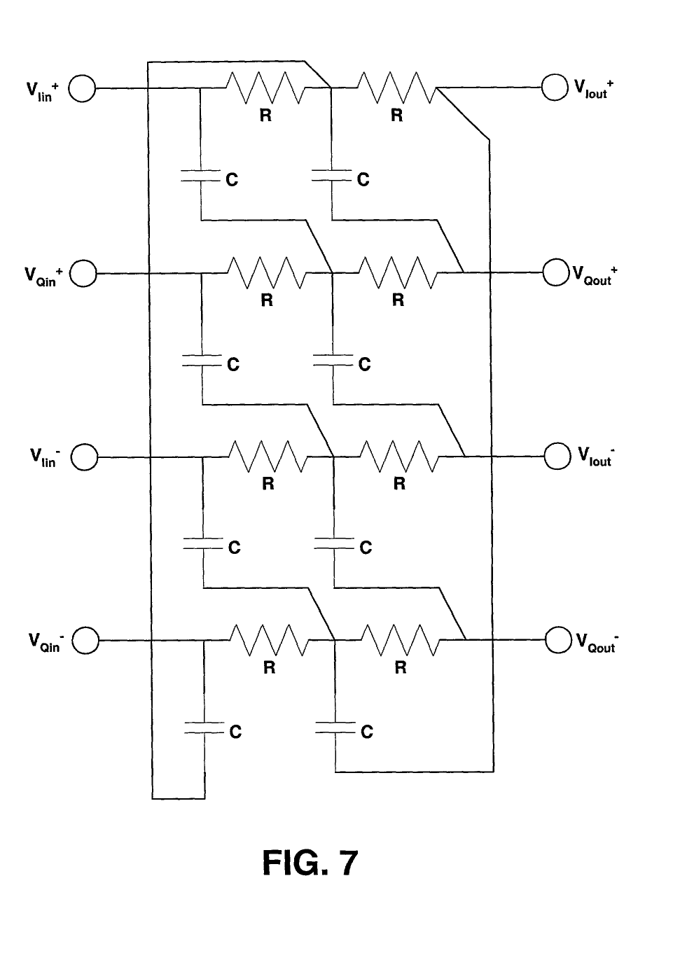

FIG. 6 depicts a conventional first order phase shifter that can be used to implement either or both of phase shifters 70 and 72. RC networks 90 and 92 generate a quadrature representation V_{oI}, V_{oQ} of the input signal Vᵢ. The resistors and capacitors in both RC networks 90 and 92 have the same values R and C. FIG. 7 illustrates a poly phase filter phase shifter that can also be used to implement either or both of phase shifters 70 and 72. It will be appreciated that other phase shifters known in the art may be substituted.

Various techniques for generating local oscillator signals for downconversion have been described as being implemented in hardware. Example hardware implementations may include implementations within a DSP, an application specific integrated circuit (ASIC), a field programmable gate array (FPGA), a programmable logic device, specifically designed hardware components, or any combination thereof.

In addition, various other modifications may be made without departing from the spirit and scope of the invention. Accordingly, these and other embodiments are within the scope of the following claims.

1. A method comprising:
receiving a first signal having a first frequency and a second signal having a second frequency, the first and second frequencies being different from a frequency of an incoming RF signal;
generating at least one local oscillator signal having a frequency determined as a function of the first and second frequencies; and
generating at least one baseband signal as a function of the local oscillator signal and the RF signal.

2. The method of claim 1, wherein the frequency of the local oscillator signal is one of a sum and a difference of the first and second frequencies.

3. The method of claim 1, wherein generating the at least one local oscillator signal comprises generating an in-phase local oscillator signal and a quadrature local oscillator signal.

4. The method of claim 1, further comprising applying the local oscillator signal to convert the RF signal down to an in-phase baseband signal and a quadrature baseband signal.

5. The method of claim 1, further comprising generating a quadrature representation of at least one of the first and second signals.

6. A wireless communication device comprising:
a downconverter to generate at least one baseband signal as a function of an RF signal and of a local oscillator signal, the local oscillator signal having a frequency determined as a function of first and second frequencies different from a frequency of the RF signal; and
a modem to demodulate the at least one baseband signal.

7. The wireless communication device of claim 6, wherein the downconverter comprises a quadrature signal generator to generate in-phase and quadrature local oscillator signals having a frequency equal to one of a sum and a difference of the first and second frequencies.

8. The wireless communication device of claim 6, further comprising:
a first frequency oscillator external to the downconverter and configured to generate a first signal having the first frequency; and
a second frequency oscillator to generate a second signal having the second frequency.

9. The wireless communication device of claim 8, wherein the second frequency oscillator is integral with the downconverter.

10. A demodulator comprising:
a quadrature signal generator to generate in-phase and quadrature local oscillator signals having a frequency determined as a function of first and second frequencies different from a frequency of an incoming RF signal;
a first mixer to generate an in-phase baseband signal as a function of the in-phase local oscillator signal and the RF signal;
a second mixer to generate a quadrature baseband signal as a function of the quadrature local oscillator signal and the RF signal; and
a modem to demodulate the in-phase and quadrature baseband signals.

11. The demodulator of claim 10, wherein the frequency of the in-phase and quadrature local oscillator signals is one of a sum and a difference of the first and second frequencies.

12. The demodulator of claim 10, further comprising:
a first frequency oscillator to generate a first signal having the first frequency; and
a second frequency oscillator to generate a second signal having the second frequency.

13. An integrated circuit comprising:
a quadrature signal generator to generate in-phase and quadrature local oscillator signals having a frequency determined as a function of first and second signals having first and second frequencies different from a frequency of an RF signal;
a downconverter to generate in-phase and quadrature baseband signals as a function of the RF signal and of the in-phase and quadrature local oscillator signals; and
a modem to demodulate the in-phase and quadrature baseband signals.

14. The integrated circuit of claim 13, wherein the frequency of the local oscillator signals is one of a sum and a difference of the first and second frequencies.

15. The integrated circuit of claim 13, further comprising a phase shifter to generate a quadrature representation of at least one of the first and second signals.

16. The integrated circuit of claim 13, wherein the quadrature signal generator is coupled to receive the first signal from a first frequency oscillator external to the integrated circuit and to receive the second signal from a second frequency oscillator.

17. The integrated circuit of claim 16, wherein the second frequency oscillator is integral with the integrated circuit.

18. A processor readable medium containing processor executable instructions for:
receiving a first signal having a first frequency and a second signal having a second frequency, the first and second frequencies different from a frequency of an RF signal;
generating at least one local oscillator signal having a frequency determined as a function of the first and second frequencies; and
generating at least one baseband signal as a function of the at least one local oscillator signal and the RF signal.

19. The processor readable medium of claim 18, wherein the frequency of the local oscillator signal is one of a sum and a difference of the first and second frequencies.

20. The processor readable medium of claim 18, further containing processor executable instructions for generating an in-phase local oscillator signal and a quadrature local oscillator signal.

21. The processor readable medium of claim 18, further containing processor executable instructions for applying the at least one local oscillator signal to convert the RF signal down to an in-phase baseband signal and a quadrature baseband signal.

22. The processor readable medium of claim 18, further containing processor executable instructions for generating a quadrature representation of at least one of the first and second signals.

23. A wireless communication device comprising:
a downconverter configured to
receive a first signal having a first frequency and a second signal having a second frequency, the first and second frequencies different from a frequency of an RF signal,
generate at least one local oscillator signal having a frequency determined as a function of the first and second frequencies, and
generate at least one baseband signal as a function of the at least one local oscillator signal and the RF signal; and
a modem to demodulate the at least one baseband signal.

24. The wireless communication device of claim 23, wherein the frequency of the local oscillator signal is one of a sum and a difference of the first and second frequencies.

25. The wireless communication device of claim 23, wherein the downconverter is configured to generate an in-phase local oscillator signal and a quadrature local oscillator signal.

26. The wireless communication device of claim 23, wherein the downconverter is configured to apply the at least one local oscillator signal to convert the RF signal down to an in-phase baseband signal and a quadrature baseband signal.

27. The wireless communication device of claim 23, wherein the downconverter is configured to generate a quadrature representation of at least one of the first and second signals.

28. An apparatus comprising:
means for receiving a first signal having a first frequency and a second signal having a second frequency, the first and second frequencies different from a frequency of an RF signal;
means for generating at least one local oscillator signal having a frequency determined as a function of the first and second frequencies; and
means for generating at least one baseband signal as a function of the at least one local oscillator signal and the RF signal.

29. The apparatus of claim 28, wherein the frequency of the local oscillator signal is one of a sum and a difference of the first and second frequencies.

30. The apparatus of claim 28, further comprising means for generating an in-phase local oscillator signal and a quadrature local oscillator signal.

31. The apparatus of claim 28, further comprising means for applying the at least one local oscillator signal to convert the RF signal down to an in-phase baseband signal and a quadrature baseband signal.

32. The apparatus of claim 28, further comprising means for generating a quadrature representation of at least one of the first and second signals.
